(19) United States
(12) Patent Application Publication
(10) Pub. No.: US 2010/0272028 A1
(43) Pub. Date: Oct. 28, 2010

(54) WIRELESS TRANSMITTER AND WIRELESS TRANSMITTING METHOD

(75) Inventors: Atsushi Matsumoto, Ishikawa (JP); Daichi Imamura, Kanagawa (JP); Sadaki Futagi, Ishikawa (JP); Takashi Iwai, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, OSAKA (JP)

(21) Appl. No.: 12/160,401

(22) PCT Filed: Jan. 17, 2007
(86) PCT No.: PCT/JP2007/050603

§ 371 Date: Jul. 9, 2008

(30) Foreign Application Priority Data
Jan. 18, 2006 (JP) 2006-009848

(51) Int. Cl. H04W 72/12

(52) U.S. Cl. 370/329

(57) ABSTRACT

A wireless transmitter and a wireless transmitting method in a communication system are provided with features in which a contention based channel and a scheduled channel are time-division-multiplexed, influence of interference between the channels is reduced while receiving quality is improved even if a delay in the contention based channel takes place. In the device and method, a heading portion MCS of the scheduled channel following the contention based channel is set to be more tolerant of errors (for example, QPSK, R=⅓) than the other portion MCS (for example, 16 QAM, R=⅓) and transmission is carried out.

### TECHNICAL FIELD

The present invention relates to a radio transmitting apparatus and radio transmission method for performing time division multiplexing on channels under transmission timing control and channels not under transmission timing control and transmitting the time division multiplexed channels.

### BACKGROUND ART

The 3GPP RAN LTE (Long Term Evolution) is currently studying SC-FDMA (Single Carrier-Frequency Division Multiple Access) as an uplink transmission scheme. Furthermore, in SC-FDMA, a method of multiplexing on a radio frame, a scheduled channel, which is a channel scheduled among users, and a contention based channel, which is a channel not scheduled among users and transmitted under the initiative of the users, is also under study.

Furthermore, there is a technique called “TAC (Timing Alignment Control)” for reducing interference among users in uplink. This TAC is a transmission timing control technique for adjusting, when a base station receives data transmitted from mobile stations, transmission timings of the mobile stations so that reception timings between the plurality of mobile stations fall within a predetermined time range. Especially when block transmission for SC-FDE (Single Carrier-Frequency Domain Equalization) is carried out, data is transmitted with a CP (Cyclic Prefix) added, so that it is possible to suppress interference among users by controlling transmission timings so that differences in reception timings between the mobile stations fall within the CP.

Here, transmission timing control fora scheduled channel and a contention based channel will be explained. Transmission timing control is generally performed for a scheduled channel. On the other hand, transmission timing control may not be performed for a contention based channel. The reason is that, when an RACH (Random Access Channel) or the like used for initial connection of a mobile station is transmitted, no uplink signal has been transmitted so far, and so feedback processing necessary for transmission timing control cannot be performed. That is, the RACH have to be transmitted without being subjected to transmission timing control.

Non-Patent Document 1 proposes a configuration for performing time division multiplexing or a configuration for performing both time division multiplexing and frequency division multiplexing as a method of multiplexing a contention based channel and a scheduled channel.

### Non-Patent Document 1: NTT DoCoMo, Fujitsu, NEC, SHARP, “Physical Channels and Multiplexing in Evolved UTRA Uplink,” R1-050850, 3GPP TSG RAN WG1 Meeting #42, London, UK, 29 Aug.-2 Sep. 2005

### DISCLOSURE OF INVENTION

### Problems to be Solved by the Invention

However, as shown in FIG. 1, there is a problem with signals transmitted using the above-described technique that the probability of resulting in a packet error increases for both the contention based channel and the scheduled channel. The reason will be explained below.

Suppose a case where a mobile station transmits an RACH using a contention based channel. As described above, transmission timing control is not performed during RACH transmission, a delay is produced at reception timing of the base station. This delay increases in proportion to the distance between the base station and the mobile station. Therefore, the end portion of a subframe of the contention based channel overlaps with the start portion of a subframe of the scheduled channel (collision shown in FIG. 2) by the amount the reception timing of the contention based channel is temporally shifted backward due to a delay (propagation delay shown in FIG. 2), and interference is produced between the channels. That is, by the interference produced between both channels, the probability of resulting in a packet error increases and received quality deteriorates.

It is therefore an object of the present invention to provide a radio transmitting apparatus and a radio transmission method, in a communication system where contention based channels and scheduled channels are time multiplexed, that is, in a communication system where channels not under transmission timing control and channels under transmission timing control are time multiplexed, capable of reducing the influences of inter-channel interference between the channels not under transmission timing control and the channels under transmission timing control and preventing deterioration of received quality even when a delay is produced in the channels not under transmission timing control.

### Means for Solving the Problem

The radio transmitting apparatus according to the present invention adopts a configuration including: a setting section that has, in a contention based channel and a scheduled channel transmitted after the contention based channel, at least one of a function of setting an MCS with higher error robustness for a start portion of the scheduled channel than an MCS for other parts and a function of setting lower transmission power for an end portion of the contention based channel than transmission power for other parts; and a transmission section that transmits the contention based channel and the scheduled channel.

### ADVANTAGEOUS EFFECT OF THE INVENTION

According to the present invention, in a communication system where channels not under transmission timing control and channels under transmission timing control are time multiplexed, it is possible to reduce the influences of inter-channel interference between the channels not under transmission timing control and the channels under transmission timing control and prevent deterioration of received quality even when a delay is produced in the channels not under transmission timing control.

### BRIEF DESCRIPTION OF DRAWINGS

FIG. 1 illustrates problems to be solved by the present invention;

FIG. 2 illustrates inter-channel interference between a contention based channel and a scheduled channel;

FIG. 3 is a block diagram showing the main configuration of a radio transmitting apparatus according to Embodiment 1;

FIG. 4 is a flowchart showing details of the operation of an encoding section according to Embodiment 1;

FIG. 5 shows an example of a transmission sequence generated by Embodiment 1;

FIG. 6 is a block diagram showing the main configuration of a radio receiving apparatus according to Embodiment 1;

FIG. 7 is a block diagram showing the main configuration of a radio transmitting apparatus according to Embodiment 2;

FIG. 8 is a flowchart collectively illustrating operation steps of an encoding section, modulation section and power control section according to Embodiment 2; and

FIG. 9 shows an example of a transmission sequence generated by Embodiment 2.

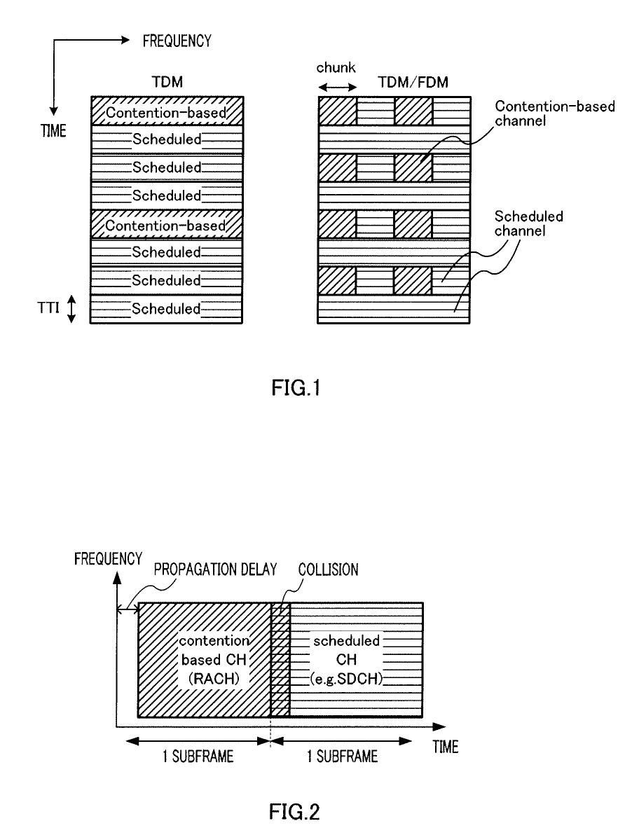

### BEST MODE FOR CARRYING OUT THE INVENTION

Embodiments of the present invention will be explained in detail below with reference to the accompanying drawings. Here, a case where the following items are assumed as premises will be explained as an example.

(1) The radio transmitting apparatus according to the present invention is mounted on a mobile station and is carrying out uplink communication.
(2) A radio transmitting apparatus adopts a DFT-s-OFDM (Discrete Fourier Transform-spread-Orthogonal Frequency Division Multiplexing) configuration.
(3) Contention based channels and scheduled channels are time division multiplexed and scheduled channels are consecutively assigned to the contention based channel.
(4) The contention based channel is transmitting an RACH and is not under transmission timing control. Therefore, the reception timing of the base station is temporally shifted backward due to a propagation delay.
(5) The scheduled channel is under transmission timing control. Therefore, the reception timing of the base station is correct.
(6) The contention based channel and the scheduled channel are transmitted from different mobile stations.
(7) Transmission power is controlled, and reception power is substantially the same among packets.
(8) Block transmission is applied whereby data is transmitted in block units with CPs added, to apply FDE (Frequency Domain Equalization) at the receiving apparatus side.
(9) The contention based channel is a channel assuming collision between users, and so MCS parameters with high error robustness are originally applied.

### Embodiment 1

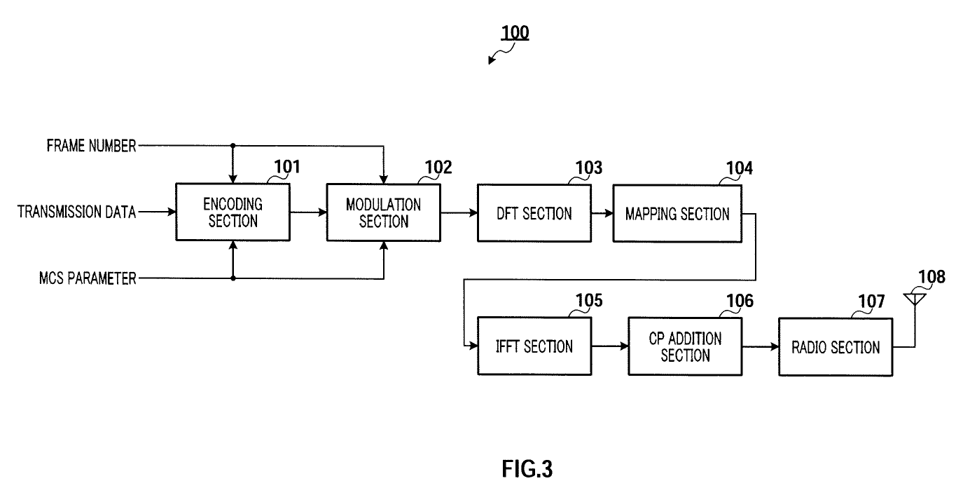

FIG. 3 is a block diagram showing the main configuration of radio transmitting apparatus 100 according to Embodiment 1 of the present invention. Embodiment 1 applies an MCS with higher error robustness to the start portions of scheduled channels consecutively transmitted after a contention based channel through time division multiplexing. In this case, the “contention based channel” is a channel not under transmission timing control and the “scheduled channel” is a channel under transmission timing control.

Radio transmitting apparatus 100 has encoding section 101, modulation section 102, DFT section 103, mapping section 104, IFFT section 105, CP addition section 106, radio section 107 and transmission antenna 108, and the respective sections operate as follows.

Encoding section 101 decides whether or not inputted transmission data corresponds to a data block that satisfies a predetermined condition based on a frame number separately inputted, and, when the transmission data does not correspond to the data block, performs error correction coding processing on the transmission data at a coding rate designated by an MCS parameter. On the other hand, when the inputted transmission data corresponds to the data block that satisfies the predetermined condition, encoding section 101 performs coding processing on the transmission data using a coding rate with higher error robustness than the coding rate designated by the MCS parameter. Details of the operation of encoding section 101 will be described later.

In the same way as encoding section 101, modulation section 102 also decides whether or not the inputted transmission data (transmission data outputted from encoding section 101) corresponds to a data block that satisfies a predetermined condition based on a frame number separately inputted, and, when the transmission data does not correspond, performs modulation processing using a modulation scheme (such as BPSK, QPSK and 16QAM) designated by the MCS parameter. Furthermore, when the transmission data corresponds to the data block that satisfies the predetermined condition, modulation section 102 applies a modulation scheme with higher error robustness than the modulation scheme designated by the MCS parameter and carries out modulation processing on the transmission data.

DFT section 103 applies a discrete Fourier transform to the modulated transmission signal outputted from modulation section 102 and converts the signal from a time waveform to frequency waveform components. Mapping section 104 maps the data converted to the frequency components on frequency resources of the radio frame according to a predetermined rule. IFFT section 105 converts the data mapped in the frequency domain to a time waveform through inverse fast Fourier transform processing. CP addition section 106 copies the end of the transmission block, adds the copy to the start of the transmission block and thereby adds a CP to the transmission signal. Radio section 107 applies predetermined radio processing such as D/A conversion and up-conversion to the transmission signal with the CP added and transmits the signal to a radio receiving apparatus through transmission antenna 108.

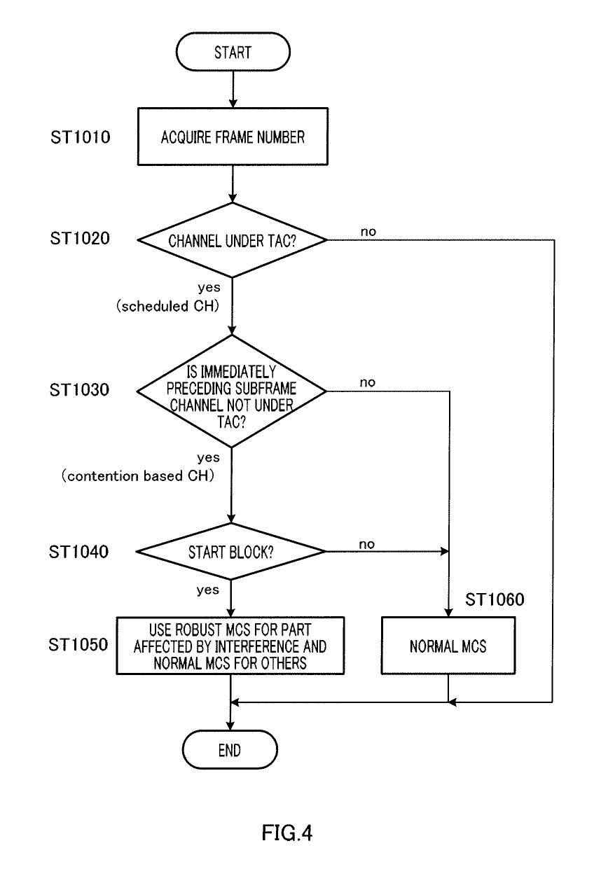

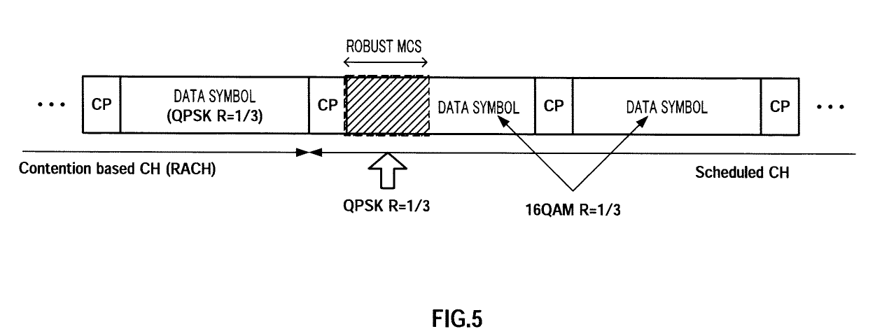

Next, details of the operation of encoding section 101 will be explained using the flowchart shown in FIG. 4.

Encoding section 101 acquires a frame number of the inputted transmission data first (ST1010) and decides whether or not this transmission data belongs to a channel under transmission timing control (TAC) (more specifically, scheduled channel) (ST1020). When the transmission data belongs to a channel not under transmission timing control, the processing ends (ST1020: NO).

When the transmission data is decided to belong to the channel under transmission timing control (scheduled channel), it is then decided whether or not the immediately preceding subframe corresponds to the channel not under transmission timing control (ST1030).

In ST1030, when the immediately preceding subframe is decided to correspond to a channel not under transmission timing control, it is further decided whether or not the data to be subjected to coding processing corresponds to the start block of the subframe (ST1040).

When the data is decided to correspond to the start block in ST1040, encoding section 101 performs coding processing on the signal portion affected by interference, of the transmission signal, that is, signal portion where the contention based channel and the scheduled channel may possibly cause inter-channel interference, using a coding rate with higher error robustness than the coding rate designated by a separately inputted MCS parameter. That is, a more robust MCS parameter is selected for the portion affected by interference than those for other parts (ST1050).

On the other hand, when the immediately preceding subframe is decided not to correspond to a channel not under transmission timing control in ST1030 or when the data to be encoded is decided not to correspond to the start block of the subframe in ST1040, encoding section 101 performs error correction coding processing on the data at a coding rate according to the inputted MCS parameter (ST1060).

In this way, encoding section 101 decides whether or not the data to be encoded satisfies the predetermined condition based on the inputted frame number. More specifically, encoding section 101 decides whether or not the transmission data is data of a channel under transmission timing control (scheduled channel), whether or not the subframe to be transmitted corresponds to a subframe transmitted immediately after the contention based channel, and, further, whether or not the data to be encoded corresponds to a transmission block at the start of a subframe. When these conditions are satisfied, robust coding is performed.

Modulation section 102 only performs modulation processing instead of coding processing in ST1050 or ST1060 in the above-described flow, and the basic operation is the same as that of encoding section 101.

FIG. 5 shows an example (frame format of the transmission signal) of a transmission sequence generated through the above-described operation of encoding section 101 and modulation section 102. As shown in this figure, an MCS with higher error robustness is set for the start block of a scheduled channel that follows a contention based channel (QPSK, R=⅓ in the example of the figure) than the MCS for other parts (16 QAM, R=⅓ in the example of the figure).

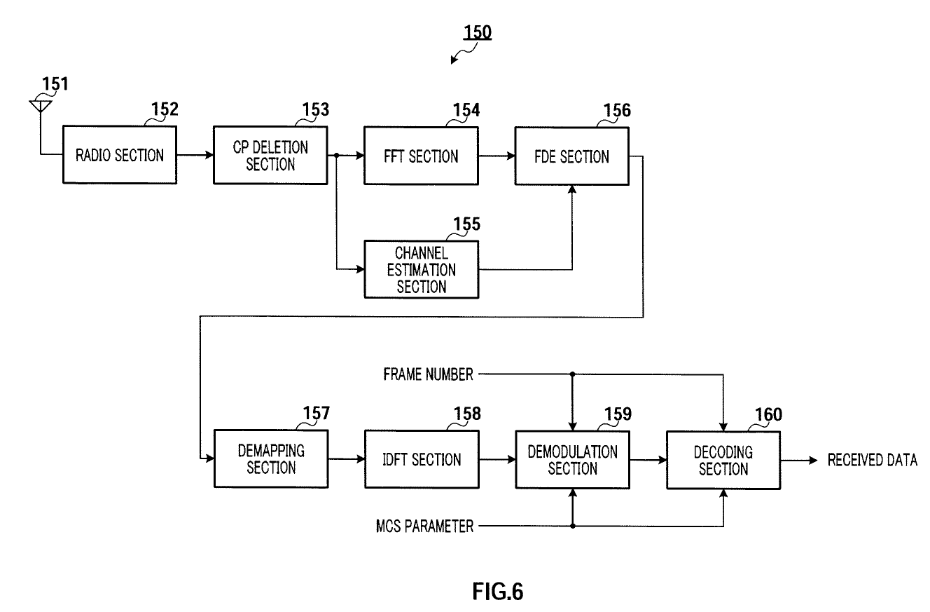

Next, radio receiving apparatus 150 according to the present embodiment, which supports above-described radio transmitting apparatus 100, will be explained. FIG. 6 is a block diagram showing the main configuration of radio receiving apparatus 150.

Radio section 152 applies predetermined radio processing such as down-conversion and A/D conversion to the signal received through reception antenna 151. CP deletion section 153 deletes the part corresponding to the CP from the received data. FFT section 154 converts the received signal to frequency component data through a fast Fourier transform. Channel estimation section 155 estimates channel fluctuation of the received signal and calculates a channel estimated value. FDE section 156 performs equalization processing in the frequency domain on the signal outputted from FFT section 154 based on the channel estimated value estimated from channel estimation section 155. Demapping section 157 demaps the frequency component data subjected to frequency equalization from frequency resources of the radio frame according to a predetermined rule. IDFT section 158 converts the frequency domain data to time waveform data through an inverse discrete Fourier transform.

Demodulation section 159 and decoding section 160 decide whether or not the data to be processed corresponds to data to which a robust MCS parameter is applied at radio transmitting apparatus 100 depending on whether predetermined conditions are satisfied, according to steps similar to those in the flowchart shown in FIG. 4, and perform demodulation processing and decoding processing on the data using the same MCS parameter used at radio transmitting apparatus 100 based on the decision result.

As explained so far, according to the present embodiment, even under environment where a channel not under transmission timing control is delayed, overlaps with a channel under transmission timing control and causes mutual interference, or more specifically, in a situation where a contention based channel is delayed by the width of a CP or more and causes inter-channel interference with a scheduled channel, an MCS parameter with error robustness is set in the transmission signal in the area where the scheduled channel receives interference, so that it is possible to reduce the occurrence of packet errors.

Although a case has been described as an example with the present embodiment where, when an MCS parameter with higher error robustness is applied, the scope of application thereof is considered in transmission block units, the scope of application may also be considered in transmission symbol units instead of transmission block units.

Furthermore, although a case has been described as an example with the present embodiment where encoding section 101 selects a coding rate with higher error robustness for a signal where inter-channel interference is likely to be produced and modulation section 102 selects a modulation scheme with higher error robustness, it is also possible to consider a coding rate and a modulation scheme (that is, MCS parameter) collectively and select such a coding rate and a modulation scheme that totally improve the error robustness. For example, it is also possible to adopt a configuration that sets only one of the coding rate and the modulation scheme to have higher error robustness.

Furthermore, although a configuration has been described as an example with the present embodiment where channel estimation section 155 on the receiving side performs channel estimation from a reception pilot signal before a fast Fourier transform, it is also possible to adopt a configuration that performs channel estimation from frequency components of the reception pilot signal after the fast Fourier transform.

### Embodiment 2

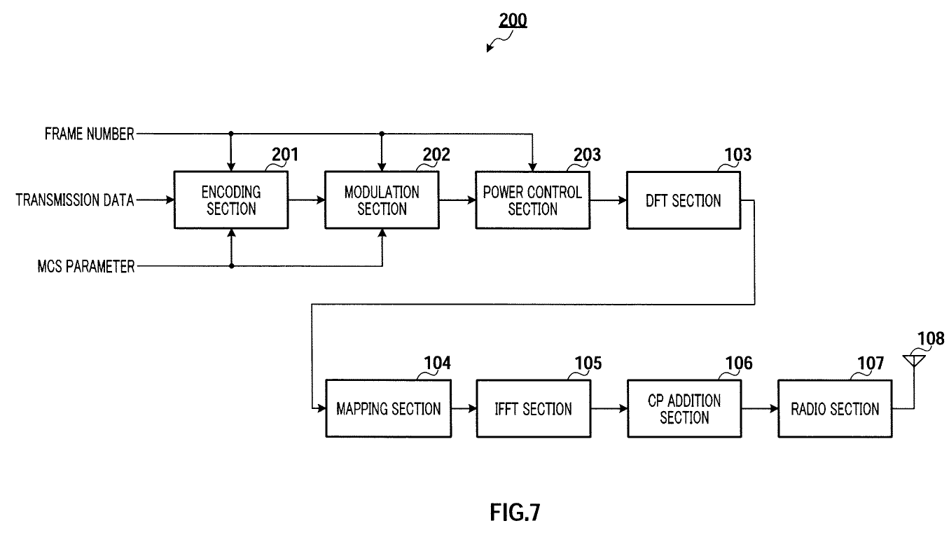

FIG. 7 is a block diagram showing the main configuration of radio transmitting apparatus 200 according to Embodiment 2 of the present invention. This radio transmitting apparatus 200 has a basic configuration similar to that of radio transmitting apparatus 100 (see FIG. 3) shown in Embodiment 1 and the same components will be assigned the same reference numerals without further explanations.

Radio transmitting apparatus 200 further has power control section 203 that performs control to reduce transmission power on the end portion of a channel not under transmission timing control, more specifically, the end portion of a contention based channel. Furthermore, encoding section 201 and modulation section 202 further apply processing of applying an MCS parameter with higher error robustness to the corresponding end portion.

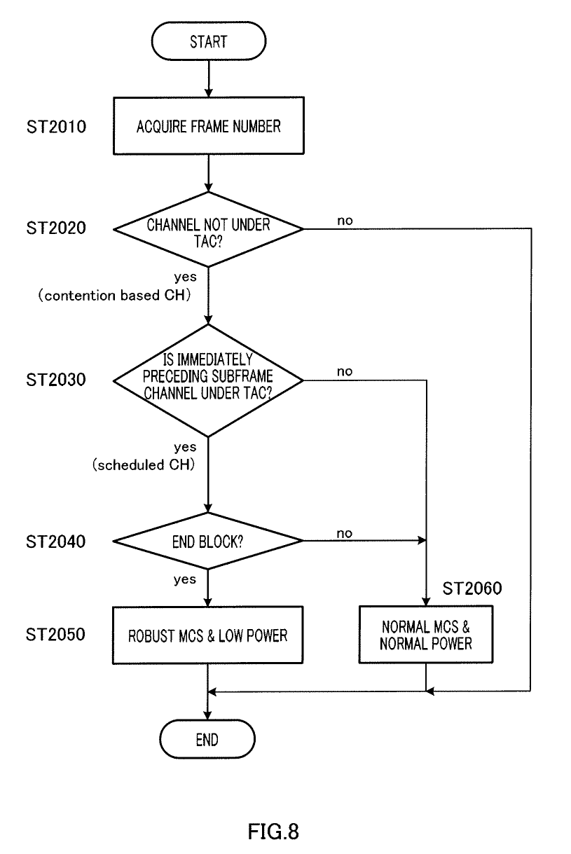

FIG. 8 is a flowchart collectively illustrating the operation steps of encoding section 201, modulation section 202 and power control section 203.

Encoding section 201 and modulation section 202 acquire a frame number (ST2010) and decide whether or not data to be processed satisfies the following predetermined condition based on this frame number. That is, it is decided whether or not the corresponding data is data for channels not under transmission timing control (contention based channel) (ST2020). When the data is decided not to correspond to data for channels not under transmission timing control, the processing ends (ST2020: NO). When the transmission data is decided to correspond to channels not under transmission timing control (contention based channels), it is decided whether or not the immediately following subframe is a subframe for channels under transmission timing control (scheduled channels) (ST2030), and it is further decided whether or not the corresponding data is a transmission block at the end of the subframe (ST2040).

When the data to be processed does not satisfy any of the above-described conditions (ST2030: NO, ST2040: NO), encoding section 201 and modulation section 202 perform coding processing and modulation processing at the coding rate and modulation scheme designated by an MCS parameter separately inputted, and power control section 203 performs transmission power control to obtain normal transmission power (ST2060).

On the other hand, when the data to be processed satisfies all the above-described conditions (ST2020: YES, ST2030: YES, ST2040: YES), encoding section 201 and modulation section 202 apply an MCS parameter with higher error robustness than the designated MCS, perform coding processing and modulation processing, and power control section 203 performs transmission power control so that the transmission power of the data has a value lower than the normal transmission power (ST2050).

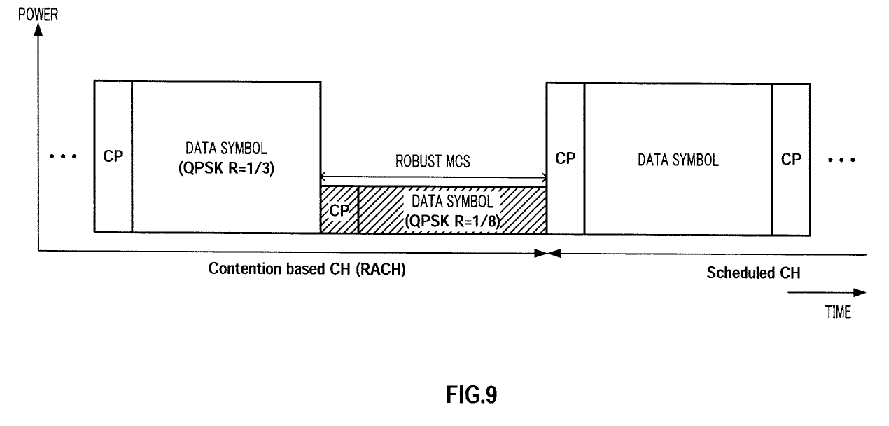

FIG. 9 shows an example of the transmission sequence (frame format of the transmission signal) generated through the above-described operation of encoding section 201, modulation section 202 and power control section 203. As shown in this figure, an MCS with higher error robustness is set for the end block of the contention based channel immediately before the scheduled channel (QPSK, R=⅛ in the example of the figure) than the MCS for other parts (QPSK, R=⅓ in the example of the figure), and the transmission power is also set to a value lower than the power for other parts.

The basic configuration of the radio receiving apparatus according to the present embodiment supporting radio transmitting apparatus 200 is similar to that of radio receiving apparatus 150 shown in Embodiment 1 (see FIG. 6). That is, through steps similar to those in the flowchart shown in FIG. 8, demodulation section 159 and decoding section 160 decide whether or not the data to be processed is data to which a robust MCS parameter is applied at radio transmitting apparatus 200 depending on whether predetermined conditions are satisfied, and carry out demodulation processing and decoding processing on the data using the same MCS parameter used at radio transmitting apparatus 200 based on the decision result.

According to the present embodiment in this way, even when a contention based channel not under transmission timing control is received with a delay, the transmission power at the end portion of the channel is set to a low level and a robust MCS is also applied, and therefore the amount of interference against the scheduled channel is small. Therefore, it is possible to reduce packet errors in both the scheduled channel and contention based channel and improve received quality.

According to the present embodiment, the position of power control section 203 need not necessarily be immediately after modulation section 102.

The embodiments of the present invention have been explained so far.

The radio transmitting apparatus and radio transmission method according to the present invention are not limited to the above-described embodiments but can be implemented with various modifications.

The radio transmitting apparatus according to the present invention can be mounted on a communication terminal apparatus and a base station apparatus in a mobile communication system, so that it is possible to provide a communication terminal apparatus, base station apparatus and mobile communication system having operations and effects similar to those described above.

Although the above-described embodiments have explained the contention based channel and scheduled channel as an example, the present invention is not necessarily limited to these channels, and the present invention is applicable to a channel where reception timing is temporally shifted backward due to a propagation delay and a channel where reception timing is always adjusted through transmission timing control.

Furthermore, although the end block of a contention based channel and the start block of a scheduled channel have been explained as mutually interfering resources as an example, the present invention is not necessarily limited to this premise. For example, the present invention is also applicable to the end block of a contention based channel not under transmission timing control and the start block of a contention based channel under transmission timing control.

Furthermore, although a case has been described as an example where DFT and IFFT are used, the present invention is not limited to this, and, for example, IDFT may also be used instead of IFFT.

Furthermore, although a DFT-s-OFDM configuration has been explained as an example here, the present invention is not limited to this, and, in the case of distributed type frequency arrangement, a configuration using IFDMA (Interleaved Frequency Division Multiple Access) may also be adopted. Furthermore, a general single carrier transmission configuration may also be used.

Furthermore, although a case has been described as an example with the above-described embodiments where, on the assumption that frame numbers and channels are uniquely assigned, a decision to distinguish between the channels or a decision on whether or not both channels contact each other is made based on this predetermined frame format, it is also possible to adopt a configuration where such information is designated from the base station.

Furthermore, the contention based channel in the above-described embodiments is used for an RACH and the scheduled channel is transmitted through a shared channel. The shared channel may also be called “PUSCH (Physical Uplink Shared CHannel).”

Furthermore, here, the case where the present invention is implemented by hardware has been explained as an example, but the present invention can also be implemented by software. For example, the functions similar to those of the radio transmitting apparatus according to the present invention can be realized by describing an algorithm of the radio transmission method according to the present invention in a programming language, storing this program in a memory and causing an information processing section to execute the program.

Furthermore, each function block used to explain the above-described embodiments may be typically implemented as an LSI constituted by an integrated circuit. These may be individual chips or may partially or totally contained on a single chip.

Furthermore, here, each function block is described as an LSI, but this may also be referred to as “IC”, “system LSI”, “super LSI”, “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor in which connections and settings of circuit cells within an LSI can be reconfigured is also possible.

Further, if integrated circuit technology comes out to replace LSI's as a result of the development of semiconductor technology or a derivative other technology, it is naturally also possible to carry out function block integration using this technology. Application of biotechnology is also possible.

The disclosure of Japanese Patent Application No. 2006-009848, filed on Jan. 18, 2006, including the specification, drawings and abstract is incorporated herein by reference in its entirety.

### INDUSTRIAL APPLICABILITY

The radio transmitting apparatus and radio transmission method according to the present invention are applicable to a communication terminal apparatus and a base station apparatus or the like in a mobile communication system.

1. A radio transmitting apparatus comprising:
a setting section that has, in a contention based channel and a scheduled channel transmitted after the contention based channel, at least one of a function of setting a modulation and coding scheme with higher error robustness for a start portion of the scheduled channel than a modulation and coding scheme for other parts and a function of setting lower transmission power for an end portion of the contention based channel than transmission power for other parts; and
a transmission section that transmits the contention based channel and the scheduled channel.

2. The radio transmitting apparatus according to claim 1, wherein the setting section sets a modulation and coding scheme with higher error robustness for an end portion of the contention based channel for which low transmission power is set than a modulation and coding scheme for other parts.

3. A communication terminal apparatus comprising the radio transmitting apparatus according to claim 1.

4. A base station apparatus comprising the radio transmitting apparatus according to claim 1.

5. A radio transmission method comprising the steps of:
setting, in a contention based channel and a scheduled channel transmitted after the contention based channel, a modulation and coding scheme with higher error robustness for a start portion of the scheduled channel than a modulation and coding scheme for other parts or setting lower transmission power for an end portion of the contention based channel than transmission power for other parts; and
transmitting the contention based channel and the scheduled channel.
